(19) United States
(12) Patent Application Publication
(10) Pub. No.: US 2026/0307894 A1
(43) Pub. Date: Oct. 8, 2026

(54) CONTAINER DOOR RETAINER SYSTEMS

(71) Applicant: Wastequip LLC, Charlotte, NC (US)

(72) Inventors: Brett Withers, Elko, NV (US); Ryan Hays, Brush Creek, TN (US)

(21) Appl. No.: 19/639,517

(22) Filed: Apr. 6, 2026

Related U.S. Application Data
(60) Provisional application No. 63/784,417, filed on Apr. 7, 2025.

(51) Int. Cl. B65D 90/22; B65D 88/12; B65D 90/00; E05C 19/00

(52) U.S. Cl. CPC B65D 90/22; B65D 88/121; B65D 90/008; E05C 19/00

(57) ABSTRACT

A retainer assembly includes a retainer bracket including a base on a first plane and at least one arm projecting therefrom. The at least one arm extends in a second plane perpendicular to the first plane. An attachment mechanism is removably and rotatably coupled with the at least one arm and has a longitudinal axis when extended. The attachment mechanism is rotatable relative to the at least one arm between a first position, in which the longitudinal axis of the attachment mechanism extends in a first direction and is parallel with the first and second planes, and a second position, in which the longitudinal axis extends in a second direction opposite the first direction and is parallel with the first and second planes. The retainer bracket can withstand forces exceeding 6000 lbs applied in either the first or second direction when the retainer bracket is coupled with the container.

### CROSS-REFERENCE TO RELATED APPLICATIONS

The present application claims priority to U.S. Provisional Application Ser. No. 63/784,417, entitled “Container Door Retainer Systems,” filed Apr. 7, 2025, the entire disclosure of which is relied upon and incorporated by reference herein for all purposes.

### FIELD

Embodiments of the present invention relate generally to the field of material hauling containers. More particularly, certain embodiments relate to improved refuse containers, including but not limited to roll-off dumpsters, and door retainer systems and assemblies for use therewith.

### BACKGROUND

In the waste and materials hauling industry, a variety of containers are used to collect, transport, and/or dump waste, bulk, and liquid materials, among others. Such containers typically are carried on vehicles, such as trucks, or on trailers. The vehicle or trailer is provided with a hoist apparatus to load a container onto and unload the container from the vehicle or trailer, transport the container, and empty the container. Examples of hoist apparatuses include hook hoists, cable hoists, winches, forklifts, and container handlers. The containers loaded and carried by hoist apparatuses may be very heavy, especially when filled. Accordingly, and for example, hoist apparatuses may be rated for a container capacity of 20,000 or 30,000 lbs. Heavier duty hoist apparatuses can be rated for more than 30,000 lbs., in some cases up to 75,000 lbs. or greater.

One type of refuse container is known as a “roll-off container.” Roll-off containers can be used in a variety of demanding waste applications, including scrap collection, construction and remodeling, demolition, and industrial clean-up, among others. Roll-off containers are usually designated by the volume of material they can contain, such as 10, 20, 30, or 40 cubic yards. Roll-off containers are currently available from a number of companies, such as Wastequip, LLC of Charlotte, North Carolina.

FIGS. 1A-1C illustrate one example of an open-topped roll-off container 100. Container 100 comprises a container door 102, shown in a closed position in FIGS. 1A and 1B and in an open position in FIG. 1C. Container door 102 is a single side-hinged door, with hinges 104 positioned at the right sidewall 101B to rotatably attach the container door 102 to the right sidewall 101B (see FIG. 1C) opposite the left sidewall 101A.

Applicable industry standards require the use of a chain attached to container door 102 that can be used as an auxiliary safety mechanism for maintaining door 102 in the closed position during transport and in the open position during dumping. Container 100 includes a chain 110 and several retainer brackets for this purpose, including a retainer bracket 112 welded to a left sidewall 101A, retainer bracket 114 welded to container door 102, and a retainer bracket 116 welded to right sidewall 101B. Retainer bracket 114 is welded to the container door 102 with one or more links at one end of chain 110 disposed within retainer bracket 114 such that chain 110 cannot be removed from retainer bracket 114. The other end of chain 110 can be removably disposed within open slots defined in retainer brackets 112 and 114, depending on the position of door 102. Chain 110 can be a ⅜″ Grade 70 transport chain, for example.

FIG. 1B shows chain 110 attached to retainer bracket 112 to secure the container door 102 in the closed position. Container door 102 also includes projections 106A, 106B, 106B extending from a side surface 103 (see FIG. 1B) of container door 102. When the container door 102 is in the closed position, latches 108A attached to arms 108 engage projections 106A-106C to hold door 102 in place. In the event that the latches 108A fail to secure the extensions 106A-106C, chain 110 and retainer brackets 112, 114 can prevent the container door 102 from inadvertently swinging open, which could cause serious injury or death for individuals nearby. When container door 102 is in the fully opened position shown in FIG. 1C, the end of chain 110 opposite the retainer bracket 114 is attached to retainer bracket 116. This prevents container door 102 from inadvertently swinging away from the fully opened position and again causing serious injury or death to persons nearby.

The foregoing discussion is intended only to illustrate various aspects of the related art in the field of the invention at the time and should not be taken as a disavowal of claim scope.

### BRIEF SUMMARY

In various embodiments described herein, various retainer assemblies, retainer brackets, and container assemblies are provided. Components and assemblies discussed herein can hold container doors in closed and open positions via various attachment mechanisms, such as chains. In various embodiments, the retainer assemblies, retainer brackets, and container assemblies described herein permit rotation of the attachment mechanisms through predetermined angles about the attachment point for the attachment mechanism. A longitudinal axis formed by the attachment mechanism can be directed in different directions relative to the retainer brackets depending on how the attachment mechanism is being used, and as described herein, this can enable the attachment mechanism, the retainer bracket, and other components to better withstand the stress acting on these components during normal operation of the container. In other words, in various embodiments, the attachment mechanism may have more freedom to rotate relative to the retainer or retainer assembly to which it is attached, which can decrease the likelihood of failure of the retainer or retainer assembly. For example, the retainer assemblies, retainer brackets, and container assemblies described herein may be configured to withstand forces exceeding 6,000 pounds applied in multiple directions relative to a retainer bracket. Thus, when the when embodiments of the invention are used on a container, such as an open-topped roll-off container, the container door can be securely retained in a fully open position to enable unloading of material from the container and in a closed position to ensure safety during container transport.

In various embodiments described herein, the retainers, systems, and assemblies also provide maintenance benefits relative to existing retainer brackets. Where, for example, a chain attachment mechanism is broken during use, the chain can be easily replaced in the field and a new chain reattached to the container door without requiring a new chain to be welded to the door, which often happens currently and which poses additional risks and drawbacks. The ability to separate the chain from a retainer in various embodiments may also help to allow maintenance to be performed on the retainer itself, if necessary. In some embodiments, a retainer or assembly also can be removably attached to the container door to enable the retainer bracket to be easily repaired or replaced.

In accordance with one embodiment, the present invention provides a retainer assembly for use with a container. The retainer assembly comprises a retainer bracket comprising a base lying on a first plane and at least one arm projecting from the base. The at least one arm extends in a second plane perpendicular to the first plane. The retainer assembly also comprises an attachment mechanism removably and rotatably coupled with the at least one arm of the retainer bracket. The attachment mechanism has a longitudinal axis when extended. The attachment mechanism is rotatable relative to the at least one arm between a first position, in which the longitudinal axis of the attachment mechanism extends in a first direction and is parallel with both the first plane and the second plane, and a second position, in which the longitudinal axis of the attachment mechanism extends in a second direction opposite the first direction and is parallel with both the first plane and the second plane. The retainer bracket can withstand a force exceeding 6000 lbs applied in either of the first direction or the second direction when the retainer bracket is coupled with the container.

In accordance with another embodiment, the present invention provides a container assembly. The container assembly comprises a container comprising a plurality of walls, including a first side wall, a second side wall, a rear wall, and a bottom wall, and a container door pivotably attached to the first side wall so that the container door is pivotable between an open position, at which the door is parallel with the first side wall, and a closed position, at which the door is perpendicular to the first side wall and disposed in facing opposition to the rear wall. The container assembly also comprises a first retainer bracket positioned on the first side wall, a second retainer bracket positioned on the second side wall, and a retainer assembly. The retainer assembly comprises a third retainer bracket comprising a base lying on a first plane, at least one arm projecting from the base, wherein the at least one arm extends in a second plane perpendicular to the first plane, and a chain removably and rotatably coupled with the at least one arm of the third retainer bracket at an attachment point. When the door is in the open position, the chain can extend in a substantially straight line from the attachment point to the first retainer bracket, wherein when the door is in the closed position, the chain can extend in a substantially straight line from the attachment point to the second retainer bracket.

In accordance with yet another embodiment, the present invention provides a container assembly. The container assembly comprises a container comprising a plurality of walls, including a first side wall, a second side wall, a rear wall, and a bottom wall, and a container door pivotably attached to the first side wall so that the container door is pivotable between a fully opened position and a closed position. The container door defines a lateral face. The container assembly also comprises a first retainer bracket positioned on the first side wall, a second retainer bracket positioned on the second side wall, and a retainer assembly coupled with the lateral face of the container door. The retainer assembly comprises a third retainer bracket comprising a base lying on a first plane, a first arm projecting from the base, and a second arm projecting from the base and laterally spaced from the first arm. Further, the first and second arms extend in a second plane perpendicular to the first plane. Also, the retainer assembly comprises a pin extending between the first and second arms and a chain coupled with the pin. The chain is rotatable about a longitudinal axis of the pin through an angle of at least 180 degrees.

### BRIEF DESCRIPTION OF THE DRAWINGS

Reference will now be made to the accompanying drawings, which are not necessarily drawn to scale, and wherein:

FIG. 1A is a perspective view illustrating a container having a container door in a closed position with an existing chain retainer bracket attached on the container door;

FIG. 1B is an enlarged perspective view illustrating the chain retainer bracket on the container door of the container of FIG. 1A;

FIG. 1C is an enlarged view illustrating the container of FIG. 1A where the container door is in a fully open position and where another chain retainer bracket is being used to hold the container door in a fully open position;

FIG. 2A is a perspective view illustrating an example container in accordance with some embodiments discussed herein;

FIG. 2B is a left-side view illustrating the container of FIG. 2A in accordance with some embodiments discussed herein;

FIG. 2C is an enlarged view illustrating an example retainer assembly on the container of FIG. 2A in accordance with some embodiments discussed herein;

FIG. 2D is a perspective view illustrating the container of FIG. 2A in accordance with some embodiments discussed herein;

FIG. 2E is an enlarged view illustrating a retainer assembly on the container of FIG. 2A, with the retainer assembly being used to retain a container door in a closed position, in accordance with some embodiments discussed herein;

FIG. 2F is a right-side view illustrating the container of FIG. 2A where the container door is in an open position in accordance with some embodiments discussed herein;

FIG. 2G is an enlarged view illustrating the container of FIG. 2F where the retainer assembly is being used to hold the container door open in the open position in accordance with some embodiments discussed herein;

FIG. 2H is a perspective view illustrating the container of FIG. 2A where the container door is being held open in the open position in accordance with some embodiments discussed herein;

FIGS. 2I and 2J are enlarged views illustrating a retainer assembly being used to hold the container door open in the open position in accordance with some embodiments discussed herein;

FIG. 3A is a perspective view illustrating an example retainer bracket alongside a clevis pin and a cotter pin in accordance with some embodiments discussed herein;

FIG. 3B is a front view illustrating the retainer bracket of FIG. 3A in accordance with some embodiments discussed herein;

FIG. 3C is a right-side view illustrating the retainer bracket of FIG. 3A in accordance with some embodiments discussed herein;

FIG. 3D is a bottom view illustrating the retainer bracket of FIG. 3A in accordance with some embodiments discussed herein;

FIG. 3E is a left-side view illustrating the retainer bracket of FIG. 3A in accordance with some embodiments discussed herein;

FIG. 3F is a top view illustrating the retainer bracket of FIG. 3A in accordance with some embodiments discussed herein;

FIG. 3G is a cross-sectional view illustrating the retainer bracket of FIG. 3A in accordance with some embodiments discussed herein;

FIG. 3H illustrates an example finite element analysis conducted on the retainer bracket of FIG. 3A in accordance with some embodiments discussed herein;

FIG. 4A is a perspective view illustrating another example retainer bracket in accordance with some embodiments discussed herein;

FIG. 4B is a right-side view illustrating the retainer bracket of FIG. 4A with various dimensions shown in accordance with some embodiments discussed herein;

FIG. 4C is a rear view illustrating the retainer bracket of FIG. 4A with various dimensions shown in accordance with some embodiments discussed herein;

FIG. 4D is a top view illustrating the retainer bracket of FIG. 4A with various dimensions shown in accordance with some embodiments discussed herein; and

FIG. 4E illustrates an example finite element analysis conducted on the retainer bracket of FIG. 4A in accordance with some embodiments discussed herein.

FIG. 5 is a perspective view illustrating another example retainer assembly on a side face of a container door in accordance with some embodiments discussed herein; and

FIG. 6 is a perspective view illustrating another example retainer assembly on the side face of a container door in accordance with some embodiments discussed herein.

### DETAILED DESCRIPTION

Example embodiments now will be described more fully hereinafter with reference to the accompanying drawings, in which some, but not all embodiments are shown. Like reference numerals generally refer to like elements throughout. For example, reference numbers 218, 318, 418, 518, and 618 each refer to different types of retainer brackets. Additionally, any connections or attachments may be direct or indirect connections or attachments unless specifically noted otherwise.

As used herein, terms referring to a direction or a position relative to the orientation of a container or retainer bracket or assembly, such as but not limited to “vertical,” “horizontal,” “upper,” “lower,” “front,” or “rear,” refer to directions and relative positions with respect to the apparatus's orientation in its normal intended operation, as indicated in the Figures herein. Thus, for instance, the terms “vertical” and “upper” refer to the vertical direction and relative upper position in the perspectives of the Figures and should be understood in that context, even with respect to an apparatus that may be disposed in a different orientation. The term “substantially,” as used herein, should be interpreted as “nearly” or “close to”, such as to account for design and manufacturing tolerances of the apparatus.

Existing container door chain retainers suffer from several drawbacks. For example, when a chain breaks or becomes damaged during operation in the field, because one end of the chain is trapped within the retainer bracket that is welded to the door, the entire bracket must be removed from the door and/or a new bracket must be welded to the door with a new chain therein. In practice, users typically avoid this step by simply welding one end of a new chain to the door. However, that method of attachment lacks sufficient strength and reliability to ensure that the door will safely remain in the open or closed position, and as such it poses safety risks. Additionally, due to the way in which a chain such as chain 110 must be positioned within retainers 112, 114, and/or 116 described above, forces can be applied to links of the chain in unintended directions (e.g., forces that may bend a link or that are perpendicular to the longitudinal axis of the chain). Thus, the attachment method can reduce the strength of the chain. Further, certain known chain retainers are designed to withstand large forces (e.g., those greater than 5000 lbs) applied in a direction parallel with or at slight angles to their longitudinal axes, but such chain retainers will fail when subjected to large forces applied in different directions. It is known, for example, that a head of chain retainer to which a chain is attached can break off from a body of the chain retainer. This too poses safety risks.

Embodiments of the present invention relate to improved retainer brackets, retainer assemblies for container doors, and container assemblies. Among other things, embodiments of the present invention and chains used therewith can withstand significant forces applied from multiple directions, including all intended directions in which forces may be applied during use. For instance, in some embodiments, such forces can be at least 6,600 lbs. Although some preferred embodiments are discussed below in the context of rectangular, open-topped roll-off containers, those of skill in the art will appreciate that the present invention is not so limited. In particular, it is contemplated that embodiments of the present invention may be used with any suitable waste, refuse, or payload container, such as but not limited to tub-style roll-off containers, intermodal containers, and dump bodies. Further, it is contemplated that various embodiments may be used with any one or all of the four container side walls, and/or the top or bottom wall of a container. Also, various embodiments can be used with a variety of different attachment mechanisms even though certain preferred embodiments described below employ a chain.

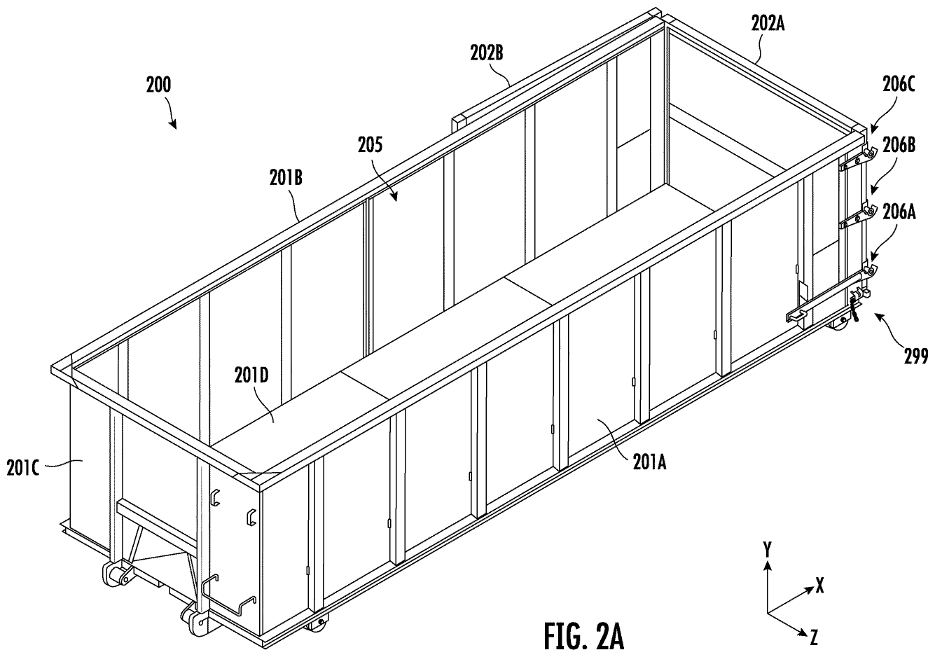

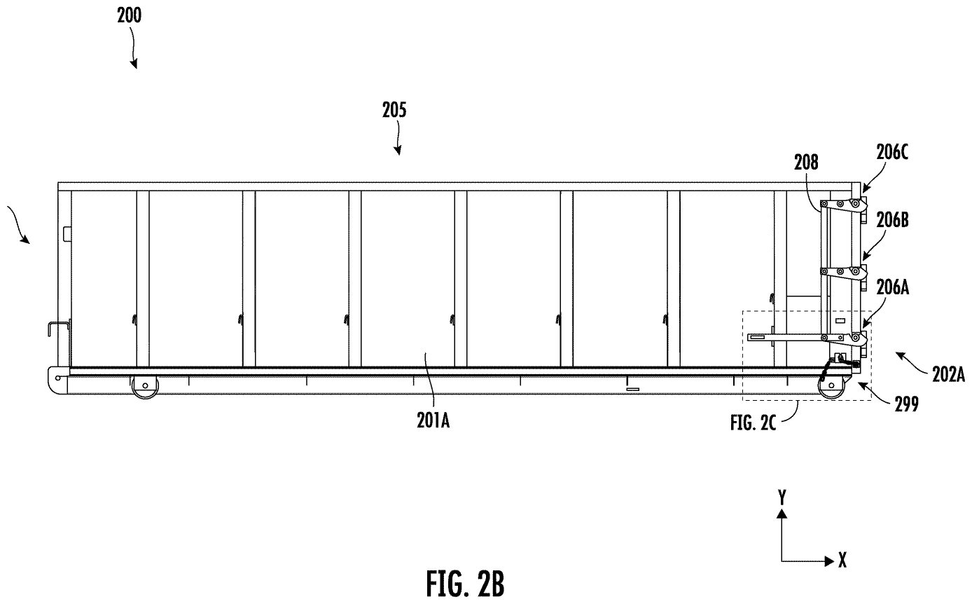

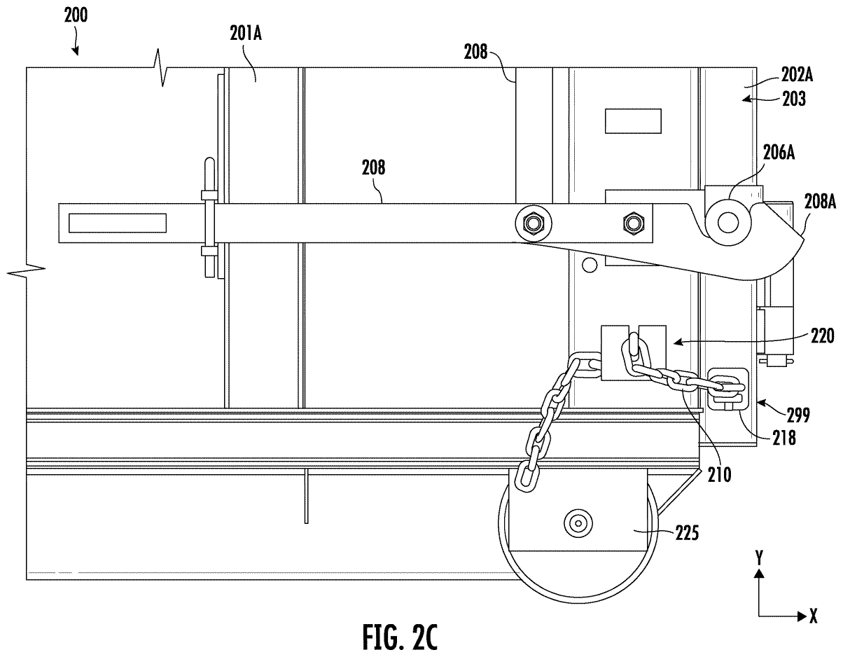

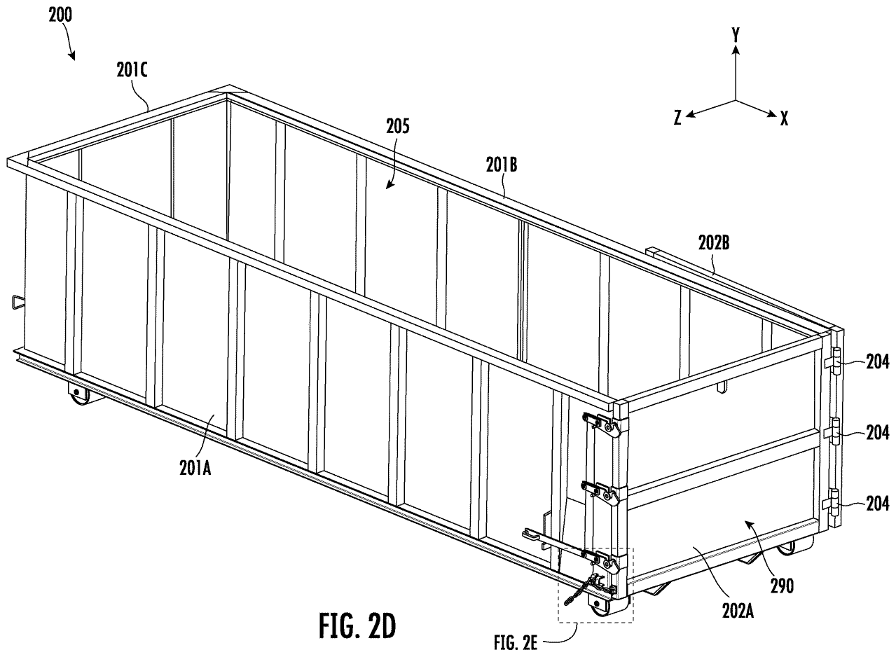

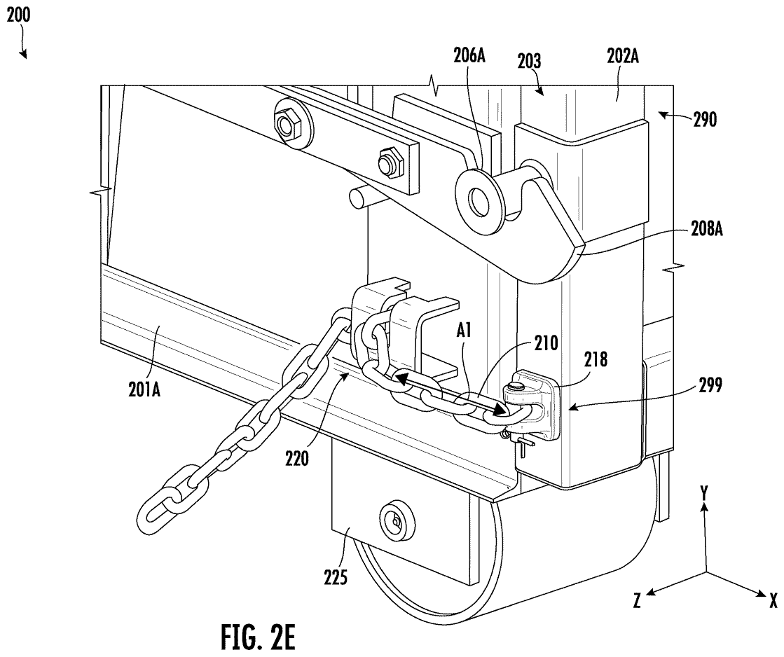

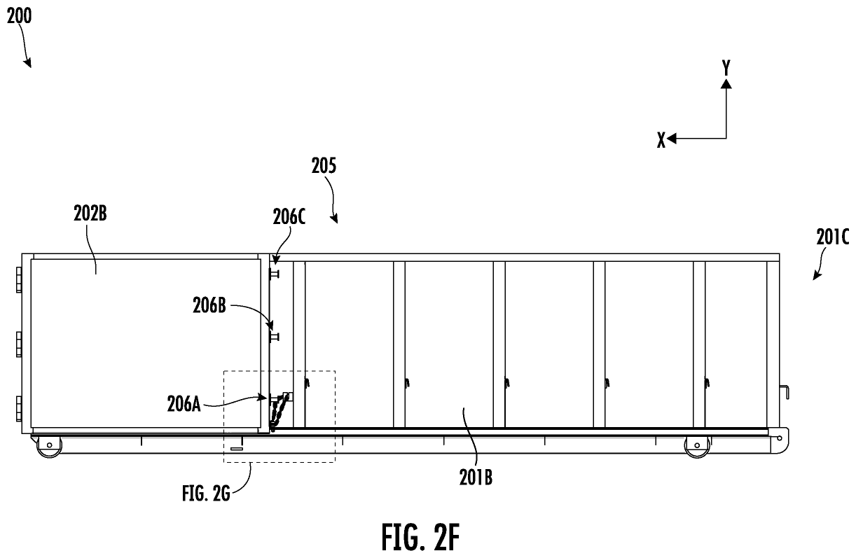

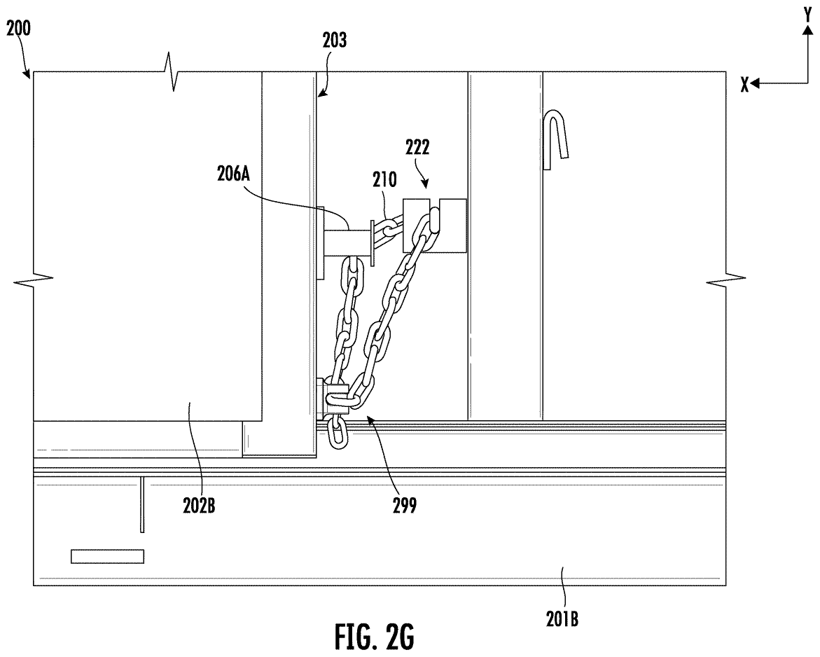

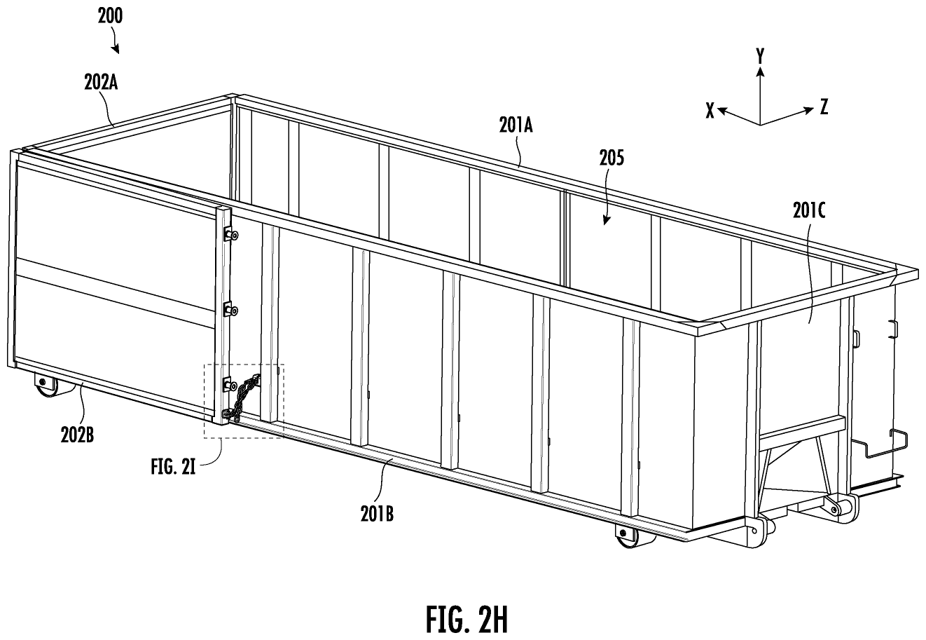

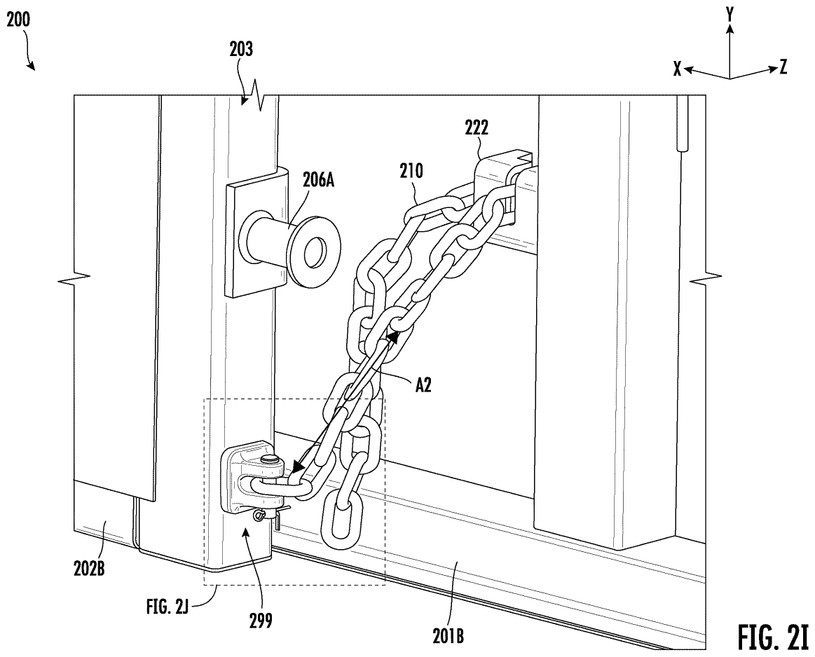

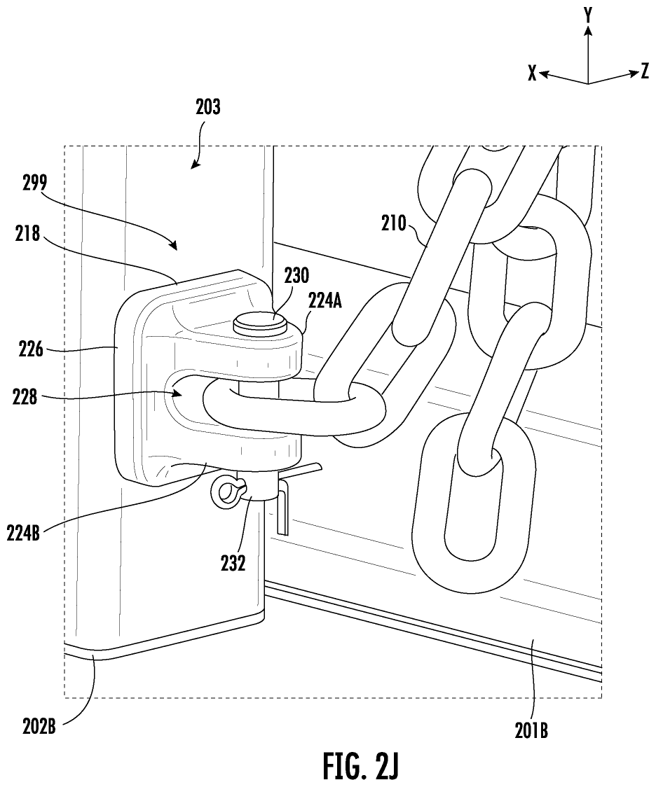

Turning now to the figures, a container having a retainer assembly in accordance with certain embodiments of the present invention is illustrated in FIGS. 2A-2J. FIG. 2A is a perspective view illustrating an example container 200, which in this embodiment is an open-topped roll-off container. The container 200 includes a left sidewall 201A, a right sidewall 201B, a rear wall 201C, and a bottom wall 201D. The container 200 also includes a container door. For the purposes of illustration, the container door is illustrated in two different positions in FIG. 2A. In this regard, reference numeral 202A illustrates the container door in a closed position, and reference numeral 202B illustrates the container door in a fully opened position. The container door is pivotable between these positions via hinges 204 (see FIG. 2D). When the container door is in the closed position 202A, the closed container door and other walls 201A-201D define an interior volume 205 within the container 200 in which refuse and other materials can be stored.

FIGS. 2B-2E illustrate an example retainer assembly 299 being used to retain the container door 202A in a closed position. FIG. 2B is a left-side view illustrating the container 200, and FIG. 2C is an enlarged view illustrating retainer assembly 299 on the container 200 being used to retain the container door in a closed position. FIG. 2D is a perspective view illustrating the container 200, and FIG. 2E is yet another enlarged view illustrating the retainer assembly 299 on the container 200.

As with container door 102, here the container door includes projections 206A, 206B, 206B extending from a side surface 203 (see FIG. 2C) of the container door. When the container door is in a closed position (as illustrated in FIGS. 2B-2C by the closed container door 202A), the projections 206A-206C can be held in place by latches 208A that are attached to and actuated via arms 208. In the event latches 208A fail to secure the projections 206A-206C or are not properly engaged therewith prior to transport, the attachment mechanism 210 and the retainers that the attachment mechanism 210 is attached to will prevent the container door from inadvertently swinging open.

As shown, retainer assembly 299 includes a retainer bracket 218 and an attachment mechanism 210. The attachment mechanism 210 is provided in the form of a chain in this example. However, attachment mechanisms described herein may also be provided in other forms, such as an attachment cable, a fastener, a strap, or the like. Attachment mechanism 210 is attached to retainer bracket 218 via a pin in this example, thereby enabling the attachment mechanism 210 to rotate about the pin relative to the retainer bracket. The pin extends in a direction parallel to the Y-axis in the retainer assembly 299 depicted in FIG. 2C, thereby allowing the attachment mechanism to rotate about the axis defined by the pin so that the attachment mechanism may extend in different directions with respect to a plane parallel to the X-Z axis (although the attachment mechanism also may extend at least partially in directions parallel to the Y-axis as illustrated in FIG. 2C).

More particularly, and with reference to FIG. 2J, in one embodiment, retainer bracket 218 comprises a base 226 and two arms 224A, 224B projecting from the base 226. Base 226 may lie on a plane parallel to the Y-Z plane in this example, and the arms 224A, 224B may project outwardly from the base 226 in planes parallel with the X-Z plane. Arms 224A, 224B are laterally spaced apart on base 226 to form a space 228 therebetween. The base 226 may be attached to the container door at the side surface 203 of the container door in this example as described in more detail below. A removable pin 232 is positioned within holes defined in the arms 224A, 224B, with the removable pin 232 having a head 230. Because of the presence of the space 228 between the arms 224A, 224B, the attachment mechanism 210 may generally rotate freely about an attachment point defined by the pin 232.

Referring again to FIG. 2C, attachment mechanism 210 is extendable to and engageable with a slot defined in a retainer bracket 220 positioned on the left sidewall 201A in this example. Retainer bracket 220, which in this example is analogous to retainer bracket 112 shown above, may be positioned at other locations on the container 200 in other embodiments, such as on the wheel cover 225 or on a bottom wall of the container 200. Retainer bracket 220 may also be positioned at other locations on the left sidewall 201A. To retain container door 202A in the closed position, attachment mechanism 210 is removably disposed within the slot defined in retainer bracket 220 as illustrated in the Figures. When it is necessary to move the container door to an open position, the attachment mechanism 210 is removed from the retainer bracket 220 so that the container door may be rotated about the hinges 204.

As illustrated in FIG. 2D, the container door defines an external face 290, and this external face 290 extends in a plane parallel to the Y-Z axis in this example. When container door 202A is closed, the external face 290 also is disposed in facing opposition to and extends parallel with the rear wall 201C and perpendicularly to planes formed by the sidewalls 201A, 201B and the bottom wall 201D. As will be appreciated, closed container door 202A engages the walls 201A, 201B, 201D so that material in the inner volume 205 is retained in the inner volume 205. When container door 202B is fully open, the external face 290 extends approximately parallel to the planes formed by the sidewalls 201A, 201B, and perpendicularly to the rear wall 201C. For example, the fully opened container door 202B may be within about 15 degrees of the right sidewall 201B, which extends parallel to the X-Y plane. Thus, in this example, the container door is configured to rotate about 270 degrees about the hinges 204 between the fully opened position and the closed position, but the container door may rotate in different amounts in other embodiments.

As discussed above, the container 200 includes hinges 204 that attach the container door to the right sidewall 201B. In this example, three hinges 204 are provided, but a different number of hinges 204 may be used in other embodiments. While the hinges 204 are attached to the right sidewall 201B and the container door, the hinges 204 may be positioned on the container door and another wall (e.g., the left sidewall 201A) so that the container door may open in a different manner.

In FIG. 2E, the container door is in a closed position and the attachment mechanism 210 extends between retainer bracket 218 and retainer bracket 220. In this extended position, the attachment mechanism 210 defines a longitudinal axis A1. In this particular case, axis A1 extends about perpendicularly to a plane defined by the external face 290 of the container door, which is parallel to the Y-Z plane in FIG. 2E, and about parallel with a lateral surface 203 of the container door, which is parallel to the X-Y plane in FIG. 2E. In various embodiments, the axis A1 may extend at an angle of less than about 30 degrees or less, about 15 degrees or less, or about 10 degrees or less relative to a direction normal to the plane defined by the external face 290 when the container door is in a closed position. Of course, in various embodiments, the angle at which axis A1 extends relative to surfaces of the door 202 and/or container 200 will depend on the relative locations of retainer brackets 218 and 220.

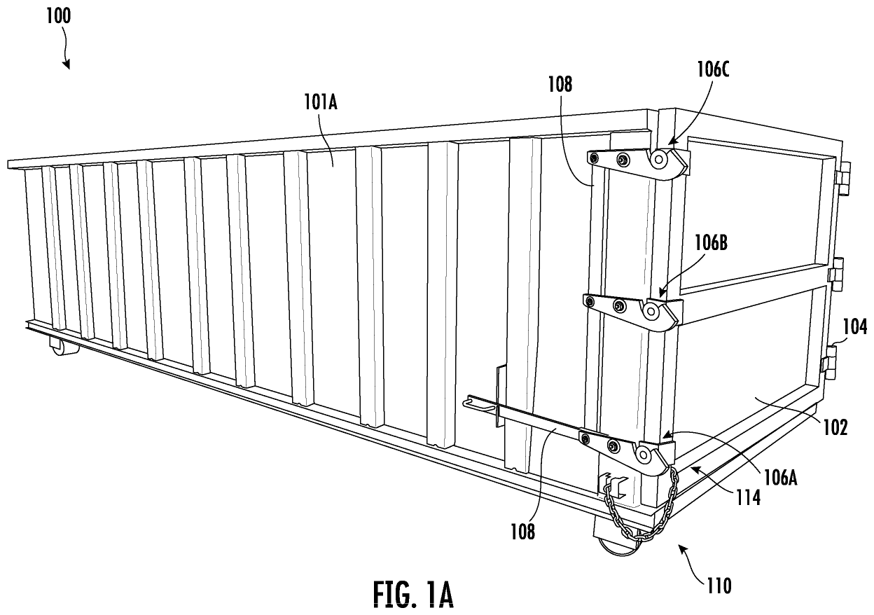

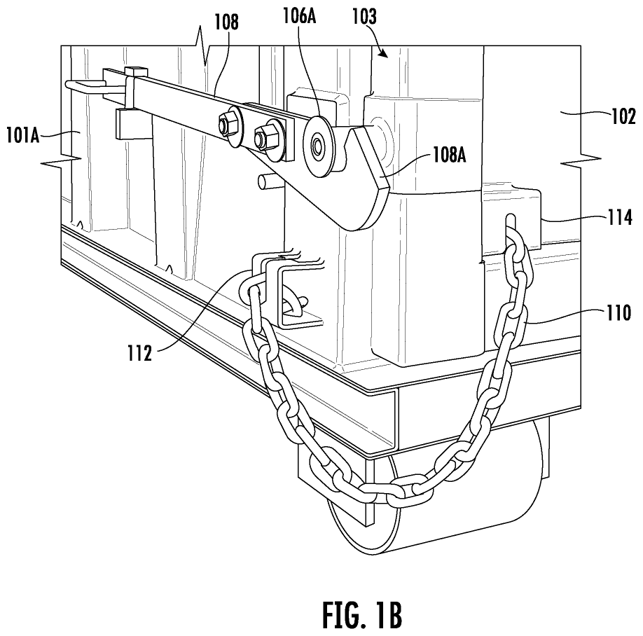

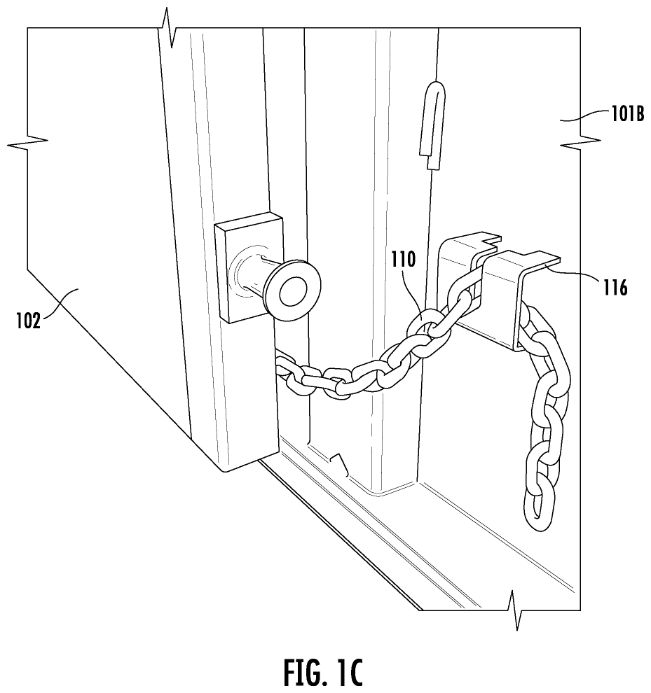

As noted, the container door defines a lateral surface 203 in this example. This lateral surface 203 extends in a plane that is about parallel to the left sidewall 201A, the right sidewall 201B, and the X-Y plane when the container door is in a closed position. In certain preferred embodiments, retainer bracket 218 is attached on lateral surface 203, e.g. via welding or mechanical fasteners or another suitable method. This may be advantageous for various reasons. For instance, in this position, retainer bracket 218 remains accessible regardless of whether the container door is in the closed position (see, e.g., FIGS. 2C and 2E) or in the fully opened position (see, e.g., FIGS. 2G and 2I). By contrast, previous retainer brackets were often positioned on a front face of the container door as illustrated in FIGS. 1A-1C. Where this is the case, the retainer brackets are difficult to access when the door is in the fully opened position as illustrated in FIG. 1C, with the retainer bracket being positioned in the small space between the fully opened container door and the right sidewall. Additionally, by placing the retainer bracket 218 on the lateral surface 203, the retainer bracket 218 avoids contacting the left sidewall 201A or the right sidewall 201B when moving to or between the fully opened position or the closed position.

FIGS. 2F-2J illustrate retainer assembly 299 being used to retain the closed container door 202A in an open position. FIG. 2F is a right-side view illustrating the container 200 of FIG. 2A where the container door is in the fully opened position. FIG. 2G is an enlarged view illustrating the container 200 of FIG. 2F. FIG. 2H is a perspective view illustrating the container 200 of FIG. 2A where the container door is being held open in the fully opened position. FIGS. 2I and 2J are respective enlarged views illustrating the retainer assembly 299 in greater detail.

In the fully opened position, the attachment mechanism 210 is extendable to and engageable with a slot defined in a retainer bracket 222. Retainer bracket 222, which in this example is analogous to retainer bracket 116 described above, is positioned on the right sidewall 201B. Retainer bracket 222 may be positioned at other locations on the container 200 in other embodiments, including at other locations on the right sidewall 201B. To retain the container door in the open position (e.g., for dumping the container 200), attachment mechanism 210 is removably disposed within the slot defined by retainer bracket 222 as illustrated in FIGS. 2G and 2I. However, when it is necessary to move the container door 202B to the closed position, the attachment mechanism 210 may be removed the retainer bracket 222 so that the container door 202B may be rotated about hinges 204.

In FIG. 2I, the container door is in a closed position and the attachment mechanism 210 extends between retainer bracket 218 and retainer bracket 222. In this extended position, attachment mechanism 210 defines a longitudinal axis A2. In this specific example, axis A2 may extend at an angle of about 30 degrees, about 15 degrees, or about 10 degrees to the external face 290 of the container door, which is about parallel to the X-Y plane in FIG. 2I. Of course, in various embodiments, the angle at which axis A2 extends relative to surfaces of the door 202 will depend on the relative locations of retainer brackets 218 and 222.

Accordingly, in various embodiments, attachment mechanism 210 is rotatable relative to the arms 224A, 224B (see FIG. 2J) of the retainer bracket 218 through a wide angle and a variety of directions. For example, attachment mechanism 210 is rotatable about its attachment point with retainer bracket 218 at least between the position shown in FIG. 2E and the position shown in FIG. 2I. In some embodiments, attachment mechanism 210 is rotatable relative to the arms 224A, 224B between a first position, in which the longitudinal axis of the attachment mechanism 210 extends in a first direction that is parallel with both the plane on which base 226 lines and with a plane parallel with arms 224A and 224B, and a second position, in which the longitudinal axis of the attachment mechanism 210 extends in a second direction opposite the first direction and is parallel with both such planes. In some embodiments, the attachment mechanism 210 is rotatable about a longitudinal axis of the pin 232 through an angle of at least 180 degrees. Also in some embodiments, when the door is in the open position, the attachment mechanism 210 can extend in a substantially straight line from the attachment point with retainer bracket 218 to retainer bracket 220 (e.g., as opposed to having to bend around door 202 and/or a portion of container 200). Likewise, when the door is in the closed position, the attachment mechanism 210 can extend in a substantially straight line from the attachment point with retainer bracket 218 to the retainer bracket 222.

In various embodiments, the attachment mechanism 210 preferably is attached to the retainer brackets 220 and/or 222 so that the attachment mechanism 210 has a limited amount of slack. For example, the attachment mechanism 210 may have less than about 6 inches of slack so that a point on the side surface 203 of the container door is allowed to travel no more than six inches from the location of that same point in the closed position or so that a point on the side surface 203 is allowed to travel no more than six inches from the location of that same point in the fully opened position. Preferably, the connection between attachment mechanism 210 and retainer brackets 220, 222 is sufficient to withstand vibration and movement of the container 200 that may occur while transporting the container or while dumping the material out of container.

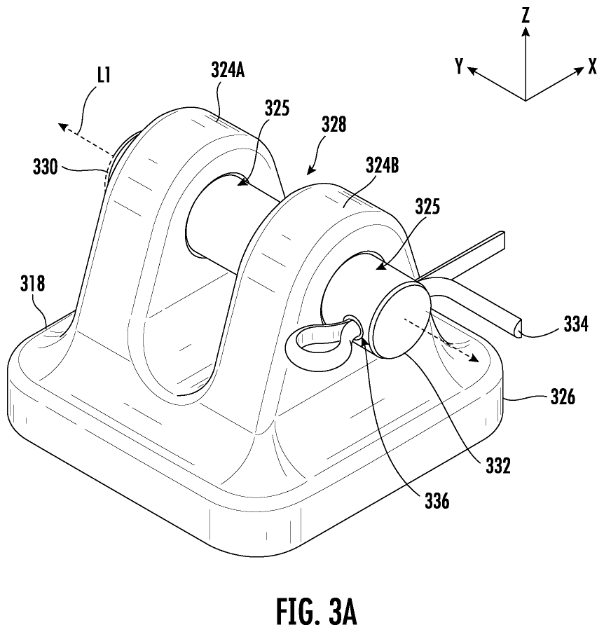

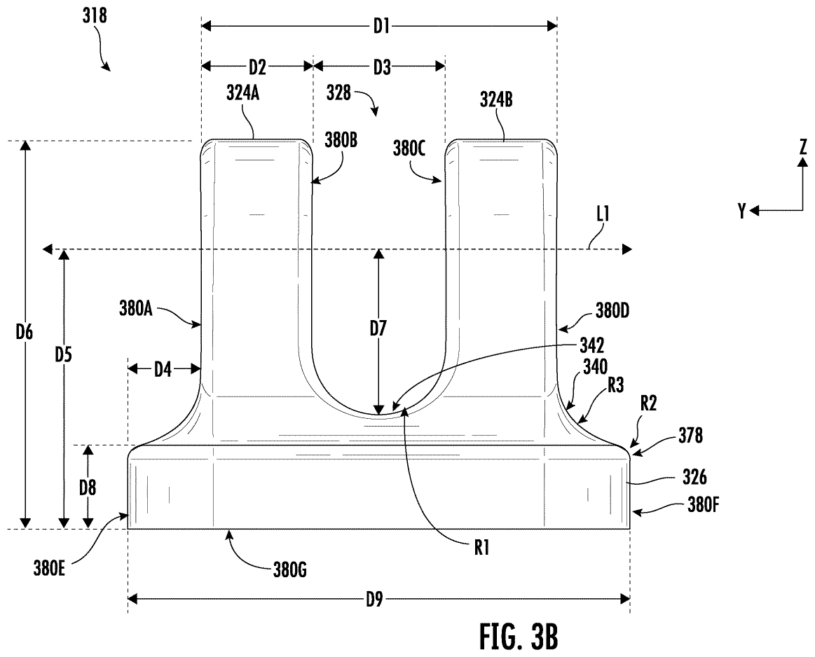

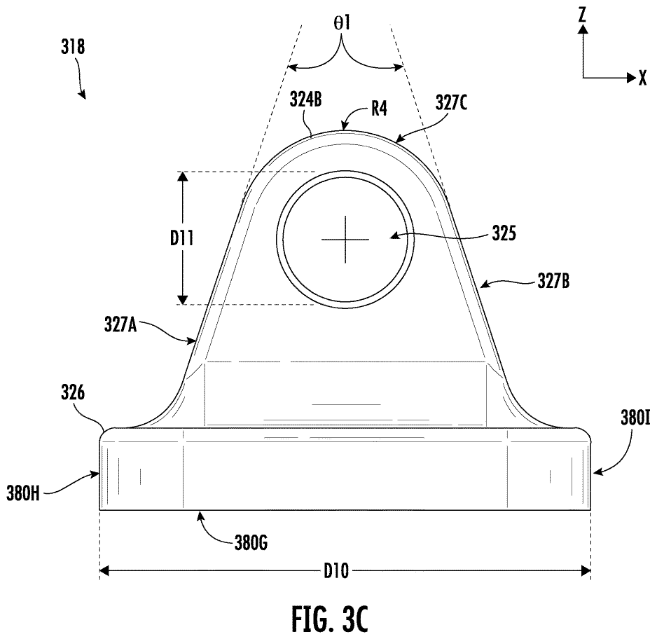

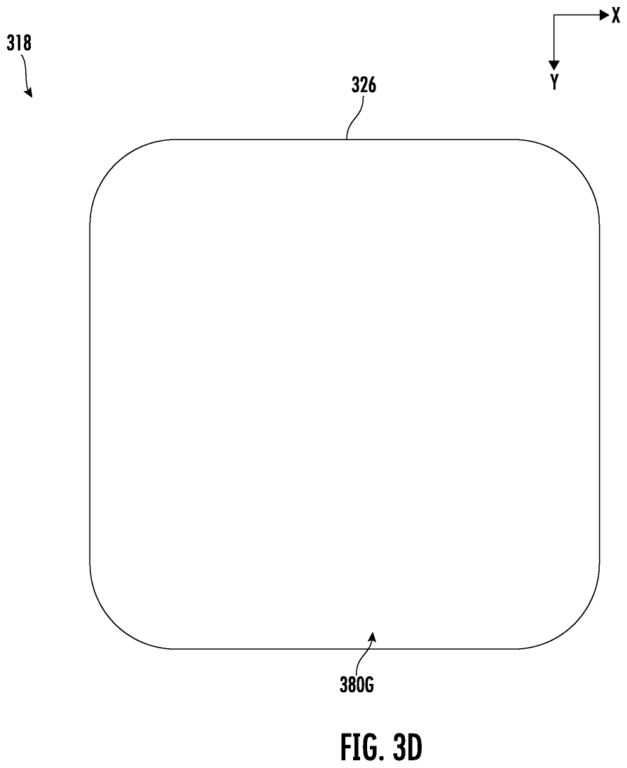

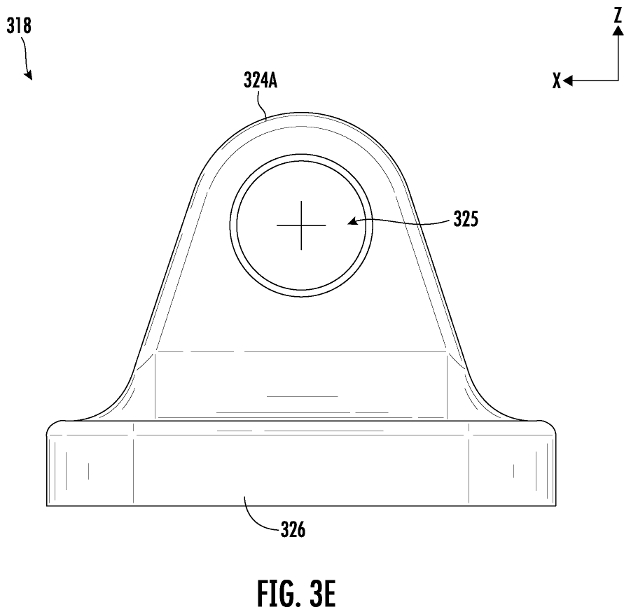

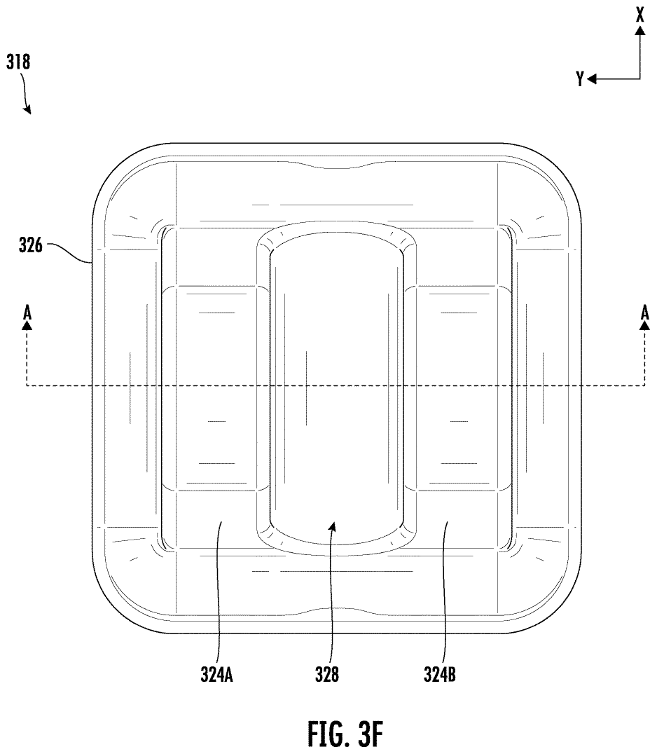

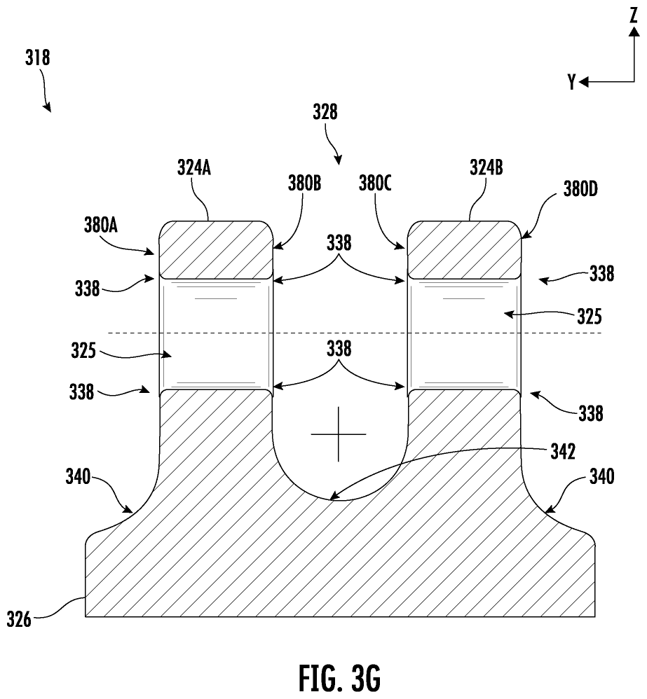

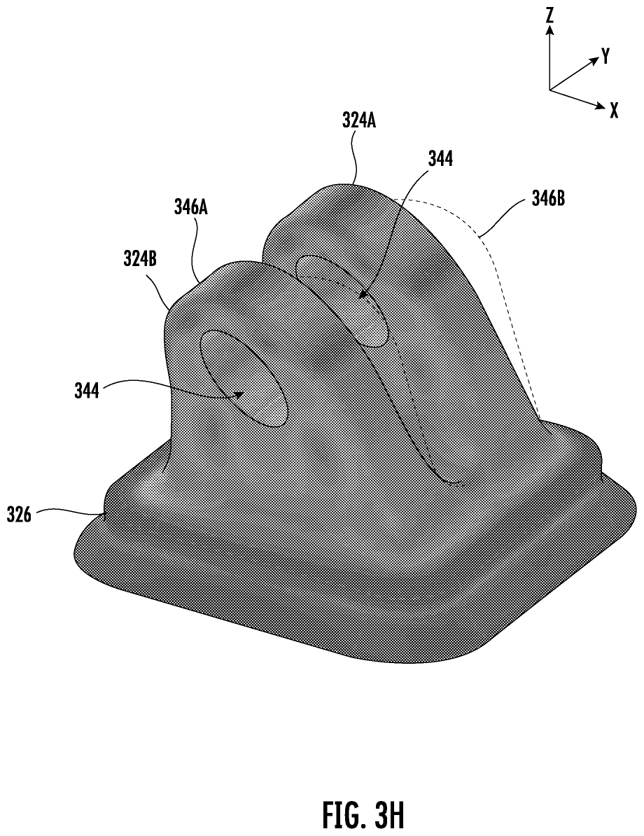

FIG. 3A illustrates an example retainer bracket 318 with which pins 332, 334 are coupled according to an embodiment of the invention. Retainer bracket 318 may be similar to the retainer bracket 218 described above in certain respects. In this regard, retainer bracket 318 can be formed of or comprise 1045 forged steel in one embodiment, but in other embodiments retainer bracket 318 can be formed of or comprise other suitable materials intended for use in industrial and commercial refuse storage and transportation operations. Where 1045 forged steel is used, the material may have a yield strength of 45 kilopounds per square inch (ksi) in one example. The 1045 forged steel also may be annealed 1045 forged steel in some embodiments.

Retainer bracket 318 comprises a base 326. The bottom of the base 326 extends parallel to the X-Y plane in this embodiment. Retainer bracket 318 also comprises a first arm 324A and a second arm 324B projecting from the base 326. The first arm 324A and the second arm 324B both extend in planes parallel to the X-Z plane in this embodiment, and those planes are perpendicular to the plane defined by the bottom of the base 326. The first arm 324A and the second arm 324B are spaced apart from each other so that a space 328 is defined between the arms 324A, 324B.

Additionally, the first arm 324A and the second arm 324B each define a hole 325 extending along a direction parallel to the Y-axis and in a direction normal to the X-Z plane in this example. To attach an attachment mechanism such as a chain, the attachment mechanism may be positioned in the space 328. Subsequently, a removable pin 332 is passed through one of the holes 325, through a portion of the attachment mechanism (e.g., within a hole defined within a link in a chain), and through another of the holes 325. Removable pin 332 can comprise a head 330 having a larger cross-sectional size relative to other portions of the removable pin 332. Thus, while other portions of the removable pin 332 may be received within the holes 325, the cross-sectional size of the head 330 prevents the head 330 from being received within the holes 325. The removable pin 332 may be provided in the form of a clevis pin in some embodiments. Furthermore, in some embodiments, another pin 334 may be received within a hole 336 defined in the removable pin 332. The pin 334 may also be removable, and the pin 334 may be provided in the form of a cotter pin in some embodiments. However, the pins 332, 334 may be provided in other forms in other embodiments. Together, the head 330 and the pin 334 assist in retaining the removable pin 332 in position relative to the retainer bracket 318.

Preferably, the retainer bracket 318 is designed to be capable of withstanding forces generated during use with an attachment mechanism (e.g., a chain) as the attachment mechanism is being used to hold a container door in an open or closed position as described herein. These forces may be applied along the longitudinal axis of the attachment mechanism in the direction that the longitudinal axis extends when the attachment mechanism is attached to a retainer bracket 220 or 222 as described above. Such forces may exceed about 5,000 pounds, about 5,500 pounds, about 6,000 pounds, or about 6,600 pounds in some embodiments. Regardless of whether the container door is in a fully opened position or a closed position, the retainer bracket may be capable of withstanding the forces applied to the attachment mechanism by the door, or material or gravity acting on the door, depending on the position of the container.

As illustrated in the front view of FIG. 3B, the first arm 324A has a first surface 380A facing in the positive Y-direction, and the first arm 324A has a second surface 380B facing in the negative Y-direction. Similarly, the second arm 324B has a first surface 380C facing in the positive Y-direction, and the second arm 324B has a second surface 380D facing in the negative Y-direction. The surfaces 380A-380D are each relatively flat surfaces in this example. A rear view of retainer bracket 318 would be identical to the front view of FIG. 3B in this example.

Various example dimensions for the retainer bracket 318 are provided. Of course, different dimensions can be used in some embodiments, as needed or desired depending on the particular application. Distance D1 extends between the first surface 380A of the first arm 324A and the second surface 380D of the second arm 324B in directions parallel to the Y-axis. The distance D1 can be about 1.600 inches or about 40.640 millimeters in one example embodiment.

Distance D2 extends between the first surface 380A of the first arm 324A and the second surface 380B of the first arm 324A in directions parallel to the Y-axis. Distance D2 can be about 0.500 inches or about 12.700 millimeters in this example. The second arm 324B also extends a similar distance between the first surface 380C and the second surface 380D of the second arm 324B.

Distance D3 extends between the second surface 380B of the first arm 324A and the first surface 380C of the second arm 324B in directions parallel to the Y-axis. Thus, the distance D3 defines the separation between the arms 324A, 324B and the size of the space 328 in directions parallel to the Y-axis. Distance D3 can be about 0.600 inches or about 15.240 millimeters in this example.

Distance D4 extends between the first surface 380A of the first arm 324A and a peripheral surface 380E of the base 326 in directions parallel to the Y-axis. Distance D4 can be about 0.325 inches or about 8.255 millimeters in this example. The peripheral surface 380F of the base 326 is opposite the peripheral surface 380E of the base 326, with the surface 380E being the farthest part of the base 326 in the positive Y-direction and with the surface 380F being the farthest part of the base 326 in the negative Y-direction. The surface 380F is separated from the second surface 380D of the second arm 324B by a similar distance D4 in directions parallel to the Y-axis.

Holes 325 extends through the arms 324A, 324B, with the line L1 in FIGS. 3A and 3B showing a centerline of these holes 325 in one embodiment. The base 326 defines a base surface 380G, which faces in the negative Z-direction in FIG. 3B. The base surface 380G is relatively flat, and the base surface 380G may be the surface of the retainer bracket 318 that is positioned against a surface of a container. The distance D5 extends between the base surface 380G and the line L1 in directions parallel to the Z-axis. The distance D5 can be about 1.250 inches or about 31.750 millimeters in this example.

Distance D6 extends in directions parallel to the Z-axis between the base surface 380G and the farthest point of the first arm 324A in the positive Z-direction. The distance D6 can be about 1.750 inches or about 44.450 millimeters in this example. The farthest point of the second arm 324B in the positive Z-direction is also positioned a distance D6 away from the base surface 380G in directions parallel to the Z-axis.

Also in this embodiment, retainer bracket 318 defines a rounded surface 342 extending between first arm 324A and second arm 324B in the space 328. A point in the center of the rounded surface 342 may be the point of the rounded surface 342 that is farthest in the negative Z-direction. This point on the rounded surface 342 is spaced a distance D7 away from the line L1 in directions parallel to the Z-axis. The distance D7 is about 0.738 inches or about 18.745 millimeters in this example. Rounded surface 342 possesses a radius of curvature R1 of about 0.300 inches or about 7.620 millimeters in this example.

Further, a rounded surface 378 is positioned along an upper (in the positive Z-direction) peripheral edge of the base 326. This rounded surface 378 may be provided in the form of a fillet. The base 326 extends a distance D8 in directions parallel to the Z-axis. The distance D8 is measured from the base surface 380G to the upper end of the rounded surface 378 in the positive Z-direction. The distance D8 is about 0.375 inches or about 9.525 millimeters in this example. The rounded surface 378 defines a radius of curvature R2 of about 0.063 inches or about 1.600 millimeters in this example.

A rounded surface 340 is illustrated on the right side of the retainer bracket 318 in FIG. 3B. The rounded surface 340 extends from the second surface 380D of the second arm 324B to the rounded surface 378 that extends around the base 326. The rounded surface 340 possesses a radius of curvature R3 of about 0.311 inches or about 7.900 millimeters in this example. The use of the rounded surface 340 and other rounded surfaces in the retainer bracket 318 may reduce stresses in the retainer bracket 318, particularly in the arms 324A, 324B.

The base 326 also extends a distance D9 in directions parallel to the Y-axis between the surface 380E and the surface 380F opposite the surface 380E. The distance D9 is about 2.250 inches or about 57.15 millimeters in this example.

Further dimensions of the example retainer bracket 318 may be seen in the right-side view of FIG. 3C. The peripheral surface 380H of the base 326 is opposite the peripheral surface 380I of the base 326, with the surface 380H being the farthest part of the base 326 in the negative X-direction and with the surface 380I being the farthest part of the base 326 in the positive X-direction. The base 326 extends a distance D10 from the surface 380H to the surface 380I in directions parallel to the X-axis. Similar to the distance D9, the distance D10 may be about 2.250 inches or about 57.15 millimeters in this example. Thus, the base 326 may generally be symmetrical and square in this embodiment.

As may be seen in FIG. 3C and FIG. 3E, the first arm 324A and the second arm 324B may each have a generally triangular cross-sectional shape in this embodiment. In FIG. 3C, the second arm 324B is shown. The second arm 324B defines a first surface 327A and a second surface 327B. The first surface 327A generally faces in the negative X-direction, albeit at a slight angle. The second surface 327B generally faces in the positive X-direction, albeit at a slight angle. The surfaces 327A, 327B may extend at an angle θ1 relative to each other. In some embodiments, this angle θ1 may be between about 30 degrees and about and about 40 degrees, between about 32 degrees and about 39 degrees, between about 34 degrees and about 38 degrees, or about 36 degrees. However, the angle θ1 may possess other values in other embodiments. Additionally, the holes 325 may define a diameter D11. The diameter D11 may be about 0.500 inches or about 12.700 millimeters in this example. The second arm 324B defines a rounded surface 327C located at its upper end along the positive Z-direction. The rounded surface 327C defines a radius of curvature R4 of about 0.500 inches or about 12.700 millimeters in this example.

The bottom of the retainer bracket 318 is illustrated in the bottom view of FIG. 3D. In the bottom view, the base surface 380G is visible. The base surface 380G defines a square shape with rounded corners in this embodiment, but the base surface 380G may possess different shapes in other embodiments (e.g., square without rounded corners, rectangular, circular, oval, polygonal, asymmetrical, etc.).

The left side of the retainer bracket 318 is illustrated in the left-side view of FIG. 3E. The geometry shown at the left side of the retainer bracket 318 matches the geometry of the retainer bracket at the right side as illustrated in FIG. 3C in this example, though that is not required in all embodiments.

A cross-sectional view along the line A-A in FIG. 3F about the line A-A is illustrated in FIG. 3G. This cross-sectional view allows chamfers and other features within the retainer bracket 318 to be seen in greater detail. The first arm 324A and the second arm 324B each define holes 325 therein. Chamfers are positioned at edges 338 around the perimeter of the holes 325 at the each of the surfaces 380A-380D. The chamfers may be provided at about 45-degree angles, and the chamfers may have a size of between about 0.020 inches and about 0.0283 inches or between about 0.508 millimeters and about 0.718 millimeters in this example.

An example finite element analysis was performed for the retainer bracket 318 illustrated in FIGS. 3A-3G. A mesh size of about 0.0625 inches or 1.5875 millimeters was used. Fixed constraints at the base, with a 0.1875 inch or 4.7625 millimeter fillet weld all the way around the perimeter of the base, also were applied. The results were based on a 6,600 pound load at the pin holes acting in the negative Z-direction.

The results of this finite element analysis are illustrated in FIG. 3H. For the finite element analysis, an initial position 346B is illustrated before any stresses were applied, and a shifted position 346A is illustrated to show how the retainer bracket 318 shifted upon application of forces on the retainer bracket 318. The base 326 is shown towards the bottom of FIG. 3H, and the base 326 has low stresses relative to other areas of the retainer bracket 318. The stresses are larger in the arms 324A, 324B than at the base 326. In particular, stresses were highest at locations 344, which were proximate to the holes 325 in the arms 324A, 324B. However, even at the locations 344, the maximum von Mises stress was just about 29 ksi, which was far below the yield strength of the material used for the retainer bracket 318 (e.g., 45 ksi). In most locations within the retainer bracket 318, the von Mises Stresses were under 22.5 ksi. Also with this setup, the maximum von Mises stress at the weld joints was just around 27 ksi. Thus, the von Mises stresses were below the yield strength of the material used for the retainer bracket 318 at all locations.

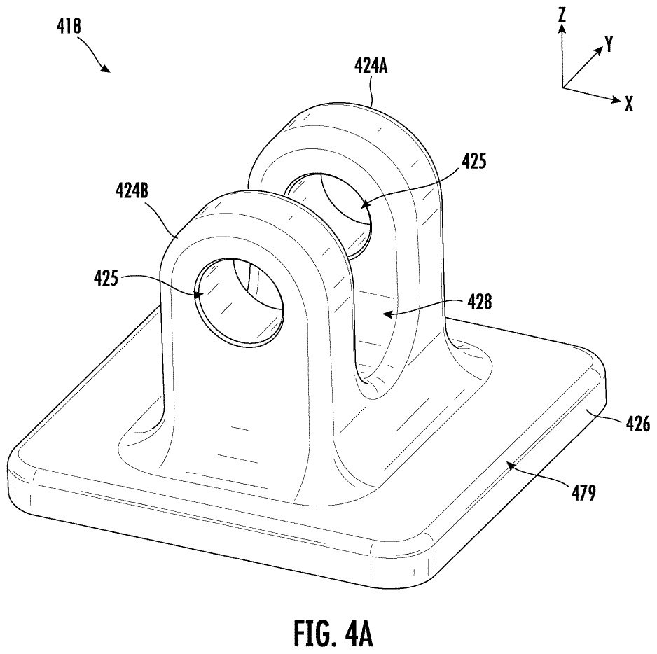

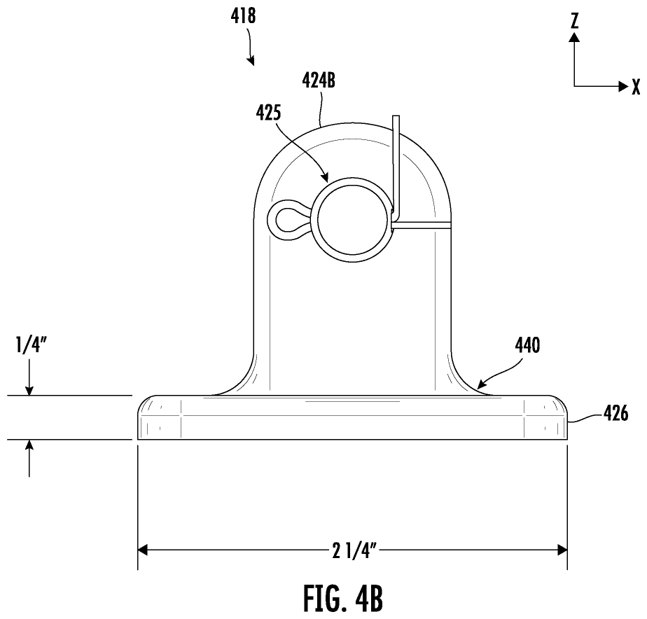

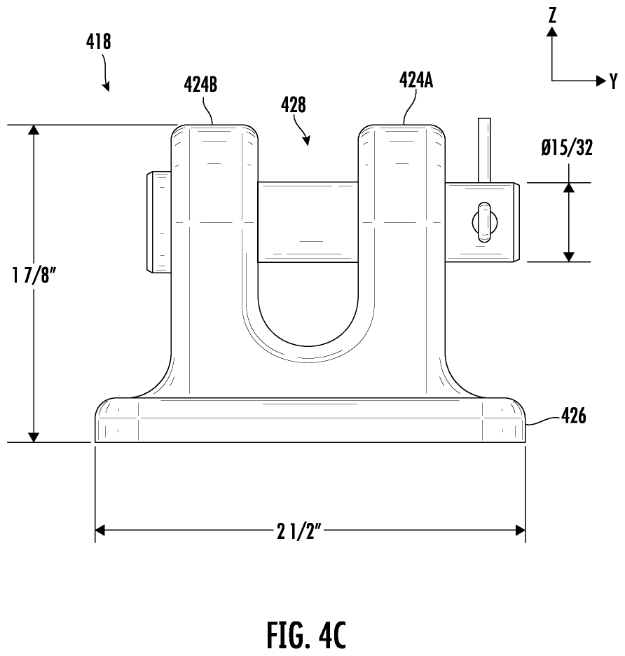

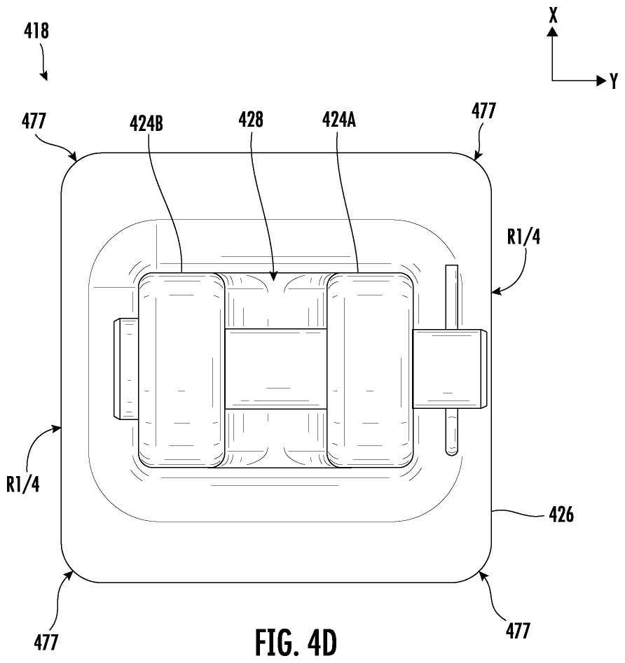

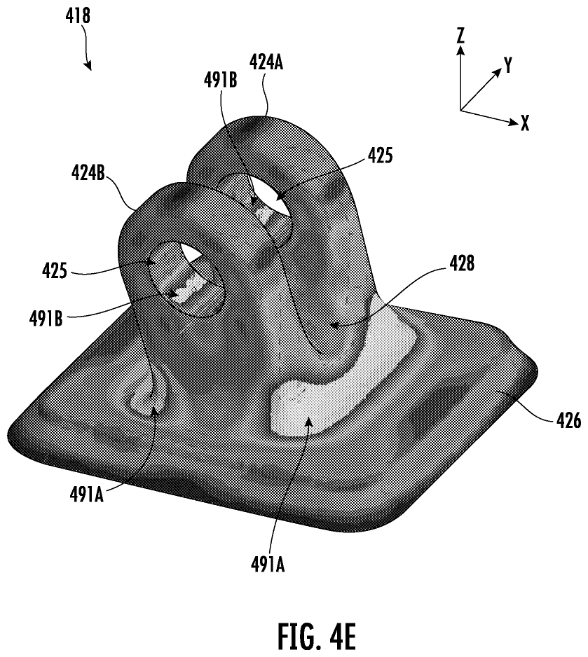

The finite element analysis for the retainer bracket 318 produced significantly better results than those obtained for retainer brackets having other geometries. For example, another example retainer bracket 418 is illustrated in FIG. 4A. Similar to the retainer bracket 318, the retainer bracket 418 includes a base 426 that generally extends in the X-Y plane, with two arms 424A, 424B extending outwardly from the base in the X-Z plane. A space 428 is positioned between the arms 424A, 424B. Furthermore, the arms 424A, 424B both comprise holes 425 extending through the arms 424A, 424B. Additionally, the base 426 has rounded corners 479 around the upper perimeter of the base 426 as illustrated in FIG. 4A, with these rounded corners having a radius of curvature of about 0.25 inches or about 6.35 millimeters in this example.

The retainer bracket 418 is also illustrated in the right-side view of FIG. 4B, in the rear view of FIG. 4C, and in the top view of FIG. 4D, with various dimensions being shown in the views of FIGS. 4B-4D. As illustrated in FIG. 4B, the retainer bracket 418 includes rounded surfaces 440 having a radius of curvature of about 0.3125 inches or about 7.9375 millimeters in this example. The base 426 has a thickness of about 0.25 inches or about 6.35 millimeters in the Z-directions in this embodiment. The base 426 also defines a rounded square shape in a plane parallel to the X-Y plane, with a width from side-to-side of about 2.5 inches or about 63.5 millimeters in both the X-directions and the Y-directions in this example.

As illustrated in FIG. 4C, the pin diameter in this example is about 0.469 inches or about 11.906 millimeters. Additionally, the height of the retainer bracket 418 from the bottom of the base 426 to the extreme tip of the arms 424A, 424B in the positive Z-directions is about 1.875 inches or about 47.625 millimeters in this example.

As illustrated in FIG. 4D, the base has rounded corners 477. These rounded corners 477 have radiuses of curvature of about 0.25 inches or about 6.35 millimeters in this embodiment. Other than the dimensions that are explicitly shown in FIGS. 4B-4D, dimensions were generally the same as those used for the retainer bracket 318.

FIG. 4E shows the results of the finite element analysis performed on retainer bracket 418. As with retainer bracket 318, the analysis assumed retainer bracket 418 being made of 1045 forged steel having a yield strength of 45 kilopounds per square inch (ksi). These results were obtained with a mesh size of about 0.0625 inches or 1.5875 millimeters for the finite element analysis. These results were also obtained with fixed constraints at the base, with a 0.1875 inch or 4.7625 millimeter fillet weld all the way around the perimeter of the base. The results were also obtained by assuming a 6,600 pound load at the pin holes acting in the negative Z-direction.

The maximum von Mises stress was above 77 ksi. The retainer bracket 418 had von Mises stresses over the yield strength of 45 ksi at a large area of the retainer bracket 418, including at the areas 491A proximate to the where the arms 424A, 424B meet the base 426. The von Mises stresses were also over the yield strength of 45 ksi at the areas 491B proximate to the holes 425 and at certain areas within the weld joints. Thus, the design of retainer bracket 318 performs significantly better than that of retainer bracket 418 in managing the stresses that can be encountered during use of retainer brackets 318, 418 as described herein.

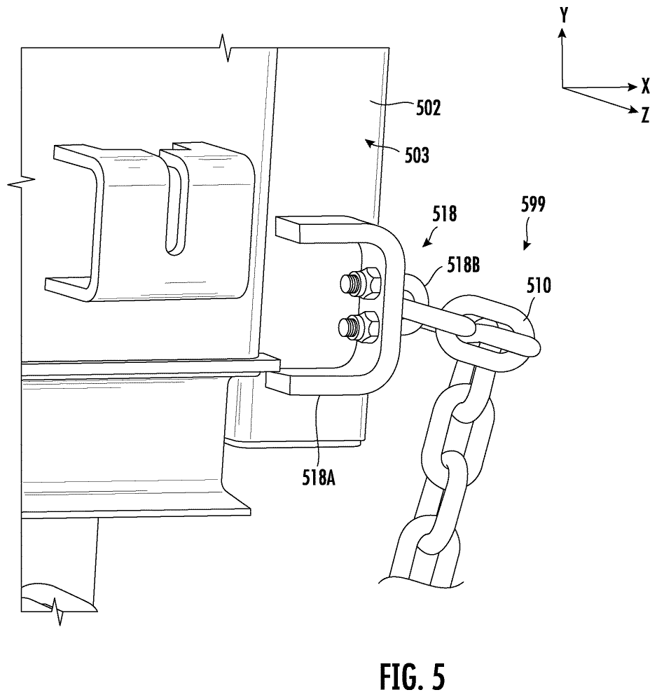

Another example retainer assembly 599 is illustrated in the perspective view of FIG. 5, with the retainer assembly 599 being positioned on a side surface 503 of a container door 502. In the retainer assembly 599, a retainer bracket 518 has an arm 518B that is removably attachable to a base 518A. For example, the arm 518B may be removably attached to the base 518A using threaded fasteners, as shown. When the arm 518B is attached to the base 518A, the arm 518B and the base 518A define a hole extending in a direction parallel to the Z-axis or in a direction normal to the X-Y plane. To attach an attachment mechanism 510 in this embodiment, the attachment mechanism 510 may be positioned relative to the base 518A, the arm 518B may be positioned relative to the attachment mechanism 510 so that the arm 518B extends through a portion of the attachment mechanism 510 (e.g., through a link of a chain), and the arm 518B may then be attached to the base 518A using the fasteners. This secures the attachment mechanism 510 within the hole formed by the arm 518B and the base 518A. In the retainer bracket 518, only one arm 518B is included. However, other retainer brackets can comprise two or more arms similar to the arm 518B in some embodiments. Furthermore, the size and shape of components in the retainer assembly 599 may differ in other embodiments.

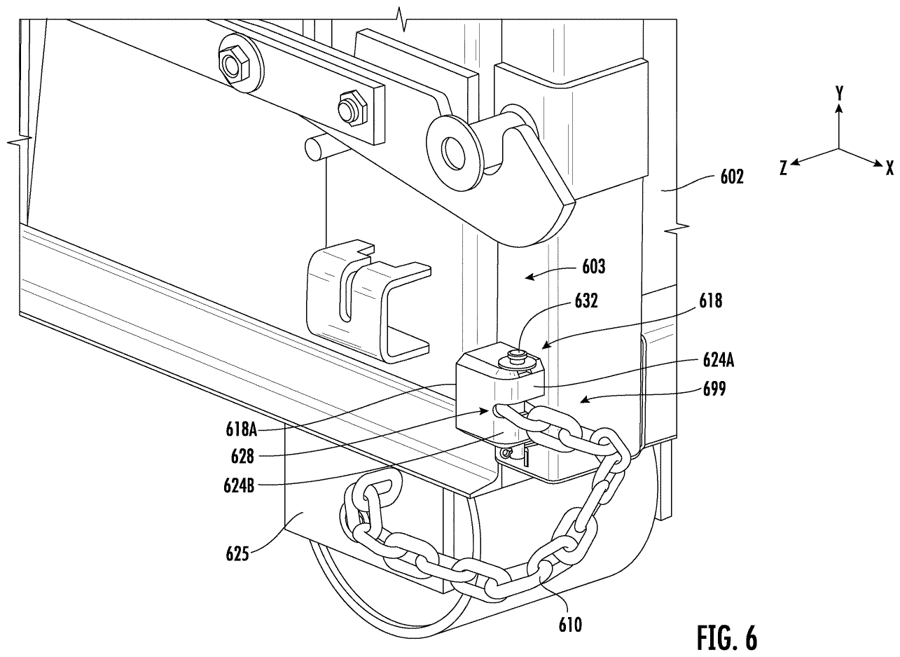

Another example retainer assembly 699 is illustrated in the perspective view of FIG. 6, with the retainer assembly 699 including a retainer bracket 618 positioned on a side surface 603 of a container door 602. In the embodiment shown in FIG. 6, retainer bracket 618 comprises a base 618A attached to the side surface 603 in a plane parallel to the X-Y plane. The retainer bracket 618 also comprises a first arm 624A and a second arm 624B projecting from the base 626. The first arm 624A and the second arm 624B both extend in an X-direction relative to the base and in an X-Z plane. The first arm 624A and the second arm 624B are spaced from each other to define a space 628 therebetween. The space 628 is relatively small in this embodiment, thereby preventing the attachment mechanism 610 from movement in the Y-direction at the attachment point (e.g., at the pin 632). However, in other embodiments, the size of the space 628 may be expanded to enable the attachment mechanism 610 to be rotated in greater amounts in the Y-direction and/or about the axis defined by the pin 632.

While various embodiments of retainer brackets, retainer systems and assemblies, and container assemblies are discussed herein, these embodiments may be modified in various ways in other embodiments. For example, the size, shape, and other features of the geometries for these features may be adjusted. Doing so may impact the strength and durability of these features. Additionally, while the retainer brackets and retainer assemblies are contemplated for use with refuse containers having a hinged container door, these apparatuses also can be used in other applications. For example, various embodiments can be used to retain doors in an open and/or closed position in other fields, such as in connection with semi-trailers, industrial freezers, etc.

### CONCLUSION

Many modifications and other embodiments set forth herein will come to mind to one skilled in the art to which these embodiments pertain having the benefit of the teachings presented in the foregoing descriptions and the associated drawings. Therefore, it is to be understood that the embodiments are not to be limited to the specific embodiments disclosed and that modifications and other embodiments are intended to be included within the scope of the invention. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the invention. In this regard, for example, different combinations of elements and/or functions than those explicitly described above are also contemplated within the scope of the invention. Although specific terms are employed herein, they are used in a generic and descriptive sense only and not for purposes of limitation.

What is claimed is:

1. A retainer assembly for use with a container, the retainer assembly comprising:
a retainer bracket comprising:
a base lying on a first plane;
at least one arm projecting from the base, wherein the at least one arm extends in a second plane perpendicular to the first plane; and
an attachment mechanism removably and rotatably coupled with the at least one arm of the retainer bracket, the attachment mechanism having a longitudinal axis when extended,
wherein the attachment mechanism is rotatable relative to the at least one arm between a first position, in which the longitudinal axis of the attachment mechanism extends in a first direction and is parallel with both the first plane and the second plane, and a second position, in which the longitudinal axis of the attachment mechanism extends in a second direction opposite the first direction and is parallel with both the first plane and the second plane;
wherein the retainer bracket can withstand a force exceeding 6000 lbs applied in either of the first direction or the second direction when the retainer bracket is coupled with the container.

2. The retainer assembly of claim 1, wherein the attachment mechanism is at least one of a chain, a cable, a fastener, or a strap.

3. The retainer assembly of claim 1, wherein the base is formed from a forged metal material and can be welded to a door of the container.

4. The retainer assembly of claim 1, wherein the base comprises a plurality of apertures dimensioned to receive fasteners suitable for attaching the base to a door of the container.

5. The retainer assembly of claim 1, further comprising:
a removable pin, wherein the at least one arm comprises a first arm and a second arm spaced apart from the first arm, wherein the removable pin is received in apertures defined in the first arm and the second arm.

6. The retainer assembly of claim 1, wherein the at least one arm includes only one arm and the arm comprises a hole extending in a direction normal to the second plane, and wherein the attachment mechanism is coupled with the at least one arm via the hole.

7. The retainer assembly of claim 6, wherein the arm is removably attached to the base.

8. The retainer assembly of claim 1, wherein the at least one arm has a generally triangular cross-sectional shape.

9. The retainer assembly of claim 1, wherein the retainer bracket defines rounded surfaces at locations where the at least one arm is attached to the base.

10. A container assembly comprising:
a container, comprising:
a plurality of walls, including a first side wall, a second side wall, a rear wall, and a bottom wall; and
a container door pivotably attached to the first side wall so that the container door is pivotable between an open position, at which the door is parallel with the first side wall, and a closed position, at which the door is perpendicular to the first side wall and disposed in facing opposition to the rear wall;
a first retainer bracket positioned on the first side wall;
a second retainer bracket positioned on the second side wall; and
a retainer assembly comprising:
a third retainer bracket comprising:
a base lying on a first plane;
at least one arm projecting from the base, wherein the at least one arm extends in a second plane perpendicular to the first plane; and
a chain removably and rotatably coupled with the at least one arm of the third retainer bracket at an attachment point,
wherein when the door is in the open position, the chain can extend in a substantially straight line from the attachment point to the first retainer bracket, wherein when the door is in the closed position, the chain can extend in a substantially straight line from the attachment point to the second retainer bracket.

11. The container assembly of claim 10, wherein the container door comprises a side surface that is parallel to the second side wall when the container door is in the closed position, and wherein the third retainer bracket is attached to the side surface.

12. The container assembly of claim 11, wherein the retainer assembly is positioned on the side surface such that the retainer assembly does not contact the first side wall when the door is in the open position.

13. The container assembly of claim 10, wherein the retainer assembly is capable of withstanding a force exceeding about 6,000 pounds applied along the longitudinal axis of the chain when the chain is coupled with the first retainer bracket and when the chain is coupled with the second retainer bracket.

14. The container assembly of claim 10, wherein the container is an open-topped roll-off container.

15. The container assembly of claim 10, wherein the container is an intermodal container.

16. A container assembly comprising:
a container comprising:
a plurality of walls, including a first side wall, a second side wall, a rear wall, and a bottom wall; and
a container door pivotably attached to the first side wall so that the container door is pivotable between a fully opened position and a closed position, the container door defining a lateral face;
a first retainer bracket positioned on the first side wall;
a second retainer bracket positioned on the second side wall; and
a retainer assembly coupled with the lateral face of the container door, the retainer assembly comprising:
a third retainer bracket comprising:
a base lying on a first plane;
a first arm projecting from the base and a second arm projecting from the base and laterally spaced from the first arm, wherein the first and second arms extend in a second plane perpendicular to the first plane; and
a pin extending between the first and second arms; and
a chain coupled with the pin,
wherein the chain is rotatable about a longitudinal axis of the pin through an angle of at least 180 degrees.

17. The container assembly of claim 16, wherein the retainer assembly is capable of withstanding a force exceeding 6000 lbs applied to the chain in a direction perpendicular to the longitudinal axis of the pin.
